(19) United States
(12) Patent Application Publication
(10) Pub. No.: US 2010/0237055 A1
(43) Pub. Date: Sep. 23, 2010

(54) DEFROSTING OR DEFOGGING STRUCTURE

(75) Inventors: Ingrid A. Rousseau, Clinton Township, MI (US); Xinran Xiao, Rochester Hills, MI (US)

Correspondence Address: Julia Church Dierker;Dierker & Associates, P.C., 3331 W. Big Beaver Road, Suite 109, Troy, MI, 48084-2813, US

(73) Assignee: GM GLOBAL TECHNOLOGY OPERATIONS, INC., Detroit, MI (US)

(21) Appl. No.: 12/408,659

(22) Filed: Mar. 20, 2009

(51) Int. Cl. B60L 1/02; B32B 17/00

(52) U.S. Cl. 219/203; 156/99

(57) ABSTRACT

A defrosting or defogging structure includes at least one optically transparent member and an optically transparent composite laminated to the optically transparent member(s). The optically transparent composite includes a thermally and electrically conductive filler material embedded in a polymer matrix. The filler material has at least one dimension on the nanoscale. The optically transparent composite is configured to heat the optically transparent member(s) when an electric current is applied thereto.

### TECHNICAL FIELD

The present disclosure relates generally to defogging and/or defrosting structures.

### BACKGROUND

Transparent glass or composite structures are often used for making various automotive and/or aerospace components. Such components include various transparent external parts, examples of which include windshields, mirrors, windows, backlights, headlights, and/or the like. Such transparent structures may, for example, fog up and/or frost under certain atmospheric conditions. Such fogging or frosting may, in some instances, deleteriously affect visibility through the structure.

### SUMMARY

A defrosting or defogging structure is disclosed herein. The structure includes at least one optically transparent member and an optically transparent composite laminated to the optically transparent member(s). The optically transparent composite includes a thermally and electrically conductive filler material embedded in a polymer matrix. The filler material has at least one dimension on the nanoscale. When an electric current is applied to the optically transparent composite, the composite is configured to heat the optically transparent member(s).

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic cross-sectional view of an example of a defogging and/or defrosting structure disclosed herein; and

FIG. 2 is a schematic cross-sectional view of another example of a defogging and/or defrosting structure disclosed herein.

### DETAILED DESCRIPTION

Example(s) of the defogging and/or defrosting structure, as disclosed herein, may be used for windshields, windows (including any side windows and/or the rear window(s)), headlights, backlights, or other similar automotive and/or aerospace transparent components. The structure generally includes at least one optically transparent member, and an optically transparent composite laminated to at least a portion of the optically transparent member(s). As such, the defogging and/or defrosting structure may also be referred to herein as the laminated structure. Due, at least in part, to its transparency, the structure is aesthetically pleasing for use as an external part for a mobile vehicle (examples of which include automobiles, trucks, motorcycles, buses, motor homes, planes, helicopters, boats, trains, etc.), windows for buildings (e.g., display windows, etc.), windows for other construction, and/or the like, and/or combinations thereof.

It is to be understood that the laminated structure may also be used for windows or other transparent structures for commercial or residential buildings. In such applications, the laminated structure may, for example, prevent condensation from forming on the windows and/or prevent the trapping of water (i.e., promote drying) between panes of multi-pane windows having no seals or having seals that are worn out.

The optically transparent composite includes, for example, one or more thermally and electrically conductive filler materials. Application of an electric current to the optically transparent composite promotes Joule heating of the filler materials. Subsequent heat transfer/thermal conduction through the composite and the transparent members enables heating of the overall laminated structure. The heat generated from the optically transparent composite advantageously defrosts or defogs the structure. As such, defrosting and/or defogging processes may be accomplished without having to use additional equipment such as, e.g., a heated blower.

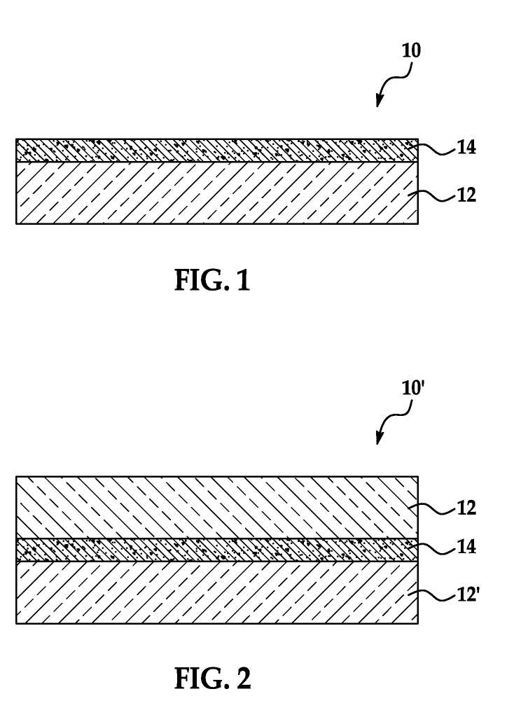

Referring now to FIG. 1, one example of the laminated structure 10 is schematically depicted. The laminated structure 10 includes the optically transparent member 12 having the optically transparent composite 14 laminated thereto. In this example, the laminated structure 10 has one optically transparent member 12.

The optically transparent member 12 is generally made from any suitable optically transparent material. In an example, the optically transparent member 12 is glass. In another example, the optically transparent member is a transparent polymer such as, for example, a polycarbonate, a polyvinyl butyral, a polyurethane, polyvinyl chloride, and/or a poly(methylmethacrylate)-based material. It is to be understood that transparent polymer may exhibit properties suitable for the end use for which the structure will be used. In instances where the transparent polymer does not exhibit such properties, a predetermined filler and/or additive may be included therein. The predetermined filler and/or the predetermined additive may be selected from materials that will suitably incorporate the desired predetermined property to the transparent polymer. Non-limiting examples of such properties includes strength, scratch resistance, audible noise reduction, transparency, impact resistance, or the like, or combinations thereof. Non-limiting examples of suitable additives include co-monomers (e.g., butyl-acrylates or other monomers including the same base material as the transparent polymer, where such co-monomers improve impact strength of poly(methylmethacrylate)-based systems or, if small amounts of the co-monomer are used, substantially prevent premature depolymerization of the base polymer), dyes (e.g., for color or ultra-violet protection), rubber toughening agents, protective coatings, impact resistant coatings, and non-limiting examples of suitable fillers include ultra-violet blocking materials (such as, e.g., titanium dioxide, zinc oxide, or the like), glass fibers, or combinations thereof.

The optically transparent member 12 may be molded or otherwise manufactured into the desirable part shape. As previously mentioned, the part size and shape may correspond with the size and shape of a window, light, etc. in, for example, a mobile vehicle, a building, or another desirable application. Manufacturing the member 12 is generally accomplished prior to lamination of the optically transparent composite 14 thereto. For example, the optically transparent member 12 is molded or manufactured using one or more conventional processes. In instances where the member 12 is formed from a thermoset material, the member 12 may be formed using compression molding. In such instances, a mold including a desired part shape may be filled with the thermoset material and subsequently cured under compressive forces and heated to cure the material and set the part shape. When the compression molding process is complete, the optically transparent composite 14 is laminated to the member 12. In instances where the member 12 is formed from a thermoplastic material, the member 12 may be formed via injection molding, extrusion molding, or the like. In one example, the thermoplastic material may be fed through an injection molding machine at a suitably high temperature (e.g., above a melting temperature of the material). The material is melted and mixed/blended while traveling through the machine. The material may then be injected into a mold having a desired part shape, and subsequently set into that part shape. When the injection molding cycle is complete, the part may be ejected from the mold and laminated with the optically transparent composite 14. In another example, the thermoplastic material may be fed through an extruder, where the material is melted and mixed/blended while traveling therethrough. It is to be understood that the shape of the die at the end of the extruder screw is in the general shape of the targeted part shape (e.g., tubular, sheet form, etc., where the die dimensions account for material expansion/contraction during thermal events). Such extrusion processes may require for the extrudate to be somewhat machined (e.g., filed, cut, etc.) prior to being casted with the optically transparent composite 14.

As briefly mentioned hereinabove, the optically transparent composite 14 is a polymer including a thermally and electrically conductive filler material 16 embedded in a polymer matrix 18. The polymer matrix 18 may be formed from thermoset materials and/or thermoplastic materials. Non-limiting examples of the polymer matrix 18 include polycarbonates, polyvinyl butyral, polyurethanes, polyvinyl chloride, poly(methylmethacrylate)s, and/or the like, and/or combinations thereof. Non-limiting examples of filler materials 16 include carbon-based nanotubes, carbon-based nanowhiskers, ceramic-based nanowhiskers, carbon-based nanowires, ceramic-based nanowires, carbon filler materials, metal particles, metal alloy particles, metal nanofibers, metal alloy nanofibers, graphite nano-platelets, and/or the like, and/or combinations thereof.

Due, at least in part, to the nanometer-sized filler materials 16, the amount of the filler materials 16 embedded in the polymer matrix 18 is lower than the amount of filler materials typically used for electric and/or thermal conduction. It is desirable that a percolating network of filler material 16 be created within the polymer matrix 18, and this network will depend, at least in part, on the amount of filler material 16 used. In instances where nanometer-sized fibers are used, the amount of filler material 16 used to form the percolated network within the polymer matrix 18 ranges from about 0.1 wt % to about 3 wt %. In instances where nanometer-sized platelets or nanometer-sized particles or spheres are used, the amount of filler material used to form the percolated network within the polymer matrix 18 ranges from about 1 wt % to about 10 wt %.

In an example where the filler material 16 includes carbon-based nanotubes, the nanotubes may be formed by growing the nanotubes on a substrate, removing the nanotubes from the substrate, and then incorporating the nanotubes into a suitable polymer matrix 18. Growth of the nanotubes, fibers, whiskers, etc. may be accomplished by applying a chemical vapor deposition process to a carbon seed or precursor material for a predetermined amount of time. Pre-formed filler materials 16 may also be used in the embodiments disclosed herein.

The filler material 16 may be embedded in the polymer matrix 18 using a mechanical mixing process. It is to be understood that other methods of embedding the filler material 16 into the matrix 18 may also be applied. For example, the mechanical mixing process may be used in combination with a process for altering the surface chemistry of the filler material 16 to facilitate dispersing of the filler material 16 into the polymer matrix 18. In another example, sonication may be used in combination with the mechanical mixing process to facilitate dispersion of the filler material 16 within the polymer matrix 18.

The filler material 16 used in the embodiments disclosed herein has at least one dimension on the nanoscale. Generally, the nanoscale ranges from about 1 nm to about 100 nm. As an example, if the filler material 16 includes carbon-based nanotubes, at least the diameter of each nanotube is on the nanoscale. It is to be understood, however, that the length of each nanotube may, in some instances, be on the nanoscale (where the length is longer than the diameter), or may, in other instances, be larger than the nanoscale. As another example, if the filler material 16 includes particulate materials, the diameter of each particle (which may be spherical/substantially spherical) is on the nanoscale. As still another example, the filler material 16 may have other three-dimensional structures (such as, e.g., the filler material 16 is provided in the form of platelets), where each platelet may have at least one dimension that is on the nanoscale, and where the other two dimensions may i) also be on the nanoscale, or ii) be larger than the nanoscale.

The polymer matrix 18 may be formed via molding or curing depending, at least in part, on the material(s) selected for the polymer. In instances where the polymer matrix 18 is formed from a thermoset material, the polymer matrix 18 may be cured to set the matrix 18 in its final part shape. In instances where the polymer matrix 18 is formed from a thermoplastic material, the matrix 18 may be molded into the final part shape. It is to be understood that the thermoplastic materials are not covalently cross-linked materials, and such materials may be molded using any conventional molding technique, such as, e.g., injection molding, blow molding, and/or the like. During cooling of the molded material, polymer chains of the thermoplastic material tend to form physical cross-links that behave substantially similarly to the covalent cross-links in thermoset materials. Such physical cross-links allow the thermoplastic material to adopt the final part shape.

The optically transparent composite 14 is laminated to the optically transparent member 12. In a non-limiting example, the composite 14 is applied to the member 12 by i) applying a thin film of the composite 14 to the member 12, and ii) heating the composite 14 to form a bond with the member 12. In another non-limiting example, the composite 14 is applied to the member 12 by i) casting or spraying a solution including the composite 14 on the member 12, and ii) applying heat thereto to a) evaporate the solvent in the solution, b) cure the composite 14, and c) bond the composite 14 to the member 12. In some instances, pressure may be used in addition to the heat to improve bonding and/or sealing of the composite 14 and the member 12. In other instances, the components 12, 14 are sealed with a transparent adhesive. In instances where the member 12 includes a laminate (e.g., polyvinyl butyral), the laminate may also serve as a suitable adhesive. In another example, the member 12 may include a separate adhesive that does not impede or otherwise deleteriously affect the transparency of the overall structure 10, non-limiting examples of which include a thin layer of acrylate-based adhesive material, a thin layer of epoxy material, or combinations thereof.

In an embodiment, the laminated structure 10 includes a substantially continuous film of the composite 14. The thickness of the film generally depends, at least in part, on application requirements, which may include, the product to be made, cost, the type of fillers used in the polymer matrix 18, and the like. In a non-limiting example, the thickness of the film ranges from about 1 μm to about 500 μm. As used herein, a “substantially continuous film” refers to a layer of the composite material 14 that is molecularly continuous when laminated to the member 12, regardless of the amount of the surface area of the member 12 that the composite 14 layer actually covers. In other words, such continuous films do not exhibit breaks, gaps, or other spaces visually noticeable by a human eye.

Another example of the laminated structure (identified by reference numeral 10′) is schematically shown in FIG. 2. In this example, the laminated structure 10′ may be, for example, a windshield for an automobile or any other transparent component that includes more than one optically transparent member 12. As shown in FIG. 2, laminated structure 10′ includes first and second members (respectively labeled 12 and 12′). Using the windshield as an example, the first and second members 12, 12′ may be first and second window panels. This embodiment of the laminated structure 10′ further includes the optically transparent composite 14 laminated between the first 12 and second 12′ optically transparent members 12, 12′.

FIGS. 1 and 2 illustrate non-limiting examples of possible cross-sectional configurations of the laminated structure 10, 10′. It is to be understood, however, that other configurations are possible. For example, the laminated structure may have three or more member(s) 12, 12′ and the composite material 14 may be laminated between two or more adjacent member(s) 12, 12. It is further to be understood that the laminated structure 10, 10′ (as shown and described in conjunction with FIGS. 1 and 2, respectively) may also be used as, for example, mirrors, headlights, windows, or other similar transparent structures or components. Such structures may be used in vehicles, as discussed herein, or in any other desirable object in which transparent structures 10, 10′ having defrosting/defogging capabilities is desired.

As previously mentioned, the examples of the laminated structure 10, 10′ disclosed herein may be used to at least one of defrost or defog the optically transparent member(s) 12, 12′. In instances where the laminated structure 10, 10′ is used for buildings or other similar structures, the laminated structure 10, 10 may be used to vaporize condensation formed on the optically transparent member(s) 12, 12′. One example of the method of defrosting or defogging the optically transparent member(s) 12, 12′ includes heating the optically transparent member(s) 12, 12′ by applying an electric current to the optically transparent composite 14. The electric current may be generated via any suitable means, for example, using one or more suitable energy sources in, for example, the automobile (or other object) in which the structure 10, 10′ is operatively incorporated. In an example, electrical leads operatively connect an electrical source to the composite 14, where such leads are integrated at an edge of the optically transparent member(s) 12, 12′ and visually out of sight. The electric current flows to the laminated composite 14 and activates the filler material 16.

The composite 14 is heated via a Joule heating effect, whereby the electric current passes through the conducting filler material 16 embedded in the polymer matrix 18 and generates heat. The heat generated by the filler material 16 is transferred to the surrounding polymer matrix 18 of the composite 14 via thermal conduction. The heat is then transferred to the optically transparent member(s) 12, 12′ which is/are adjacent to the composite 14. This heat suitably and desirably defrosts and/or defogs the laminated structure 10, 10′ without substantially impairing visibility through the structure 10, 10′ (at least in part because the structure 10, 10′ is transparent).

It is to be understood that the laminated structure 10, 10′ may be heated substantially uniformly across its surface area to defrost and/or defog the desired portions of the structure 10, 10′ (and in some instances, the entire structure 10, 10′). This is due, at least in part, to the substantially uniform distribution of the filler 16 throughout the polymer matrix 18. It is further to be understood that defrosting and/or defogging occurs relatively quickly. The quickness is due, at least in part, to the heating of the entire surface of the structure 10, 10′ at substantially the same time, as opposed to other techniques where the structure is gradually heated through, e.g., electrical leads or wires embedded (as a grid) in the structure.

While several embodiments have been described in detail, it will be apparent to those skilled in the art that the disclosed embodiments may be modified. Therefore, the foregoing description is to be considered exemplary rather than limiting.

1. A defogging or defrosting structure, comprising:
at least one optically transparent member; and
an optically transparent composite laminated to the at least one optically transparent member, the optically transparent composite including:
a polymer matrix; and
a thermally and electrically conductive filler material having at least one dimension on the nanoscale and being embedded in the polymer matrix;
wherein the optically transparent composite is configured to heat the at least one optically transparent member when an electric current is applied thereto.

2. The defogging or defrosting structure as defined in claim 1 wherein the at least one optically transparent member includes a first window panel and a second window panel, and wherein the optically transparent composite is laminated between the first and second window panels.

3. The defogging or defrosting structure as defined in claim 2 wherein the first and second window panels are made of an optically transparent glass or an optically transparent polymer.

4. The defogging or defrosting structure as defined in claim 3 wherein the optically transparent polymer is selected from polycarbonates or poly(methylmethacrylate)-based materials, and wherein the optically transparent polymer includes at least one of a predetermined functionality, a predetermined filler, or a predetermined additive.

5. The defogging or defrosting structure as defined in claim 4 wherein the at least one of the predetermined functionality, the predetermined filler, or the predetermined additive provides the optically transparent polymer with at least one property selected from strength, scratch resistance, transparency, and impact resistance.

6. The defogging or defrosting structure as defined in claim 1 wherein the optically transparent composite is laminated on the at least one optically transparent member in the form of a substantially continuous film.

7. The defogging or defrosting structure as defined in claim 1 wherein the thermally and electrically conductive filler material is selected from carbon-based nanotubes, carbon-based nanowhiskers, ceramic-based nanowhiskers, carbon-based nanowires, ceramic-based nanowires, carbon filler materials, metal particles, metal alloy particles, metal nanofibers, metal alloy nanofibers, graphite nano-platelets, and combinations thereof.

8. The defogging or defrosting structure as defined in claim 1 wherein the structure is implemented in an automobile as at least one of a rear window, a side window, or a windshield.

9. The defogging or defrosting structure as defined in claim 1 wherein when the optically transparent composite is configured to heat the at least one optically transparent member, and wherein the optically transparent composite is further configured to at least one of defrost or defog the at least one optically transparent member.

10. The defogging or defrosting structure as defined in claim 1 wherein the defogging or defrosting structure is a window, windshield, headlight, backlight, and combinations thereof, and wherein the defogging or defrosting structure is used in automobiles, trucks, motorcycles, buses, motor homes, planes, helicopters, boats, trains, or buildings.

11. A method of making a defogging or defrosting structure, comprising:
providing at least one optically transparent member; and
laminating an optically transparent composite to at least a portion of the at least one optically transparent member, the optically transparent composite including:
a polymer matrix; and
a thermally and electrically conductive filler material having at least one dimension on the nanoscale and being embedded in a polymer matrix;
wherein the optically transparent composite is configured to heat the at least one optically transparent member when an electric current is applied thereto.

12. The method as defined in claim 11 wherein the at least one optically transparent member includes a first window panel and a second window panel, and wherein prior to laminating, the method further comprises positioning the optically transparent composite between the first and second window panels.

13. The method as defined in claim 12 wherein the first and second window panels are made of an optically transparent glass or an optically transparent polymer.

14. The method as defined in claim 11 further comprising arranging the optically transparent composite in the form of a substantially continuous film prior to laminating the optically transparent composite to the at least one optically transparent member.

15. The method as defined in claim 11 wherein the thermally and electrically conductive filler material is selected from carbon-based nanotubes, carbon-based nanowhiskers, ceramic-based nanowhiskers, carbon-based nanowires, ceramic-based nanowires, carbon filler materials, metal particles, metal alloy particles, metal nanofibers, metal alloy nanofibers, graphite nano-platelets, and combinations thereof.

16. The method as defined in claim 11, further comprising incorporating the defogging or defrosting structure in an automobile as at least one of a headlight, a backlight, a rear window, a side window, or a windshield.

17. A method of defrosting or defogging a structure, comprising:
selectively applying an electric current to an optically transparent composite that is laminated to at least a portion of at least one optically transparent member of the structure, the optically transparent composite including a thermally and electrically conductive filler material embedded in a polymer matrix, and the filler material having at least one dimension on the nanoscale; and
when the electric current is applied to the optically transparent composite, heating the at least one optically transparent member.

18. The method as defined in claim 17 wherein when the at least one optically transparent member is heated, the optically transparent composite at least one of defrosts or defogs the at least one optically transparent member.

19. The method as defined in claim 17 wherein the at least one optically transparent member is heated without substantially impairing visibility through the structure.
